(19) United States
(12) Patent Application Publication
(10) Pub. No.: US 2006/0255596 A1
(43) Pub. Date: Nov. 16, 2006

(54) Flush handle latch mechanism

(76) Inventor: Teng-Long Yong, Singapore (SG)

Correspondence Address: LEWIS, BRISBOIS, BISGAARD & SMITH LLP, 221 NORTH FIGUEROA STREET, SUITE 1200, LOS ANGELES, CA, 90012, US

(21) Appl. No.: 11/125,505

(22) Filed: May 10, 2005

(51) Int. Cl. E05C 1/12

(52) U.S. Cl. 292/173

(57) ABSTRACT

The present invention provides a latch mechanism or assembly of the type commonly used on doors and on commercial cabinets and cases, and the like, that is simple to manufacture and has relatively few parts. The present invention provides a door, lid, gate, hatch, cover or other closure device latch mechanism or assembly for retaining a linearly operable bolt element securely by a striker or receiver element that is releasable from either side of the latch by operation of a rotary mechanism actuated by a flush handle on one side or a push button or push cap on the opposite side. It is emphasized that this abstract is provided to comply with the rules requiring an abstract that will allow a searcher or other reader to quickly ascertain the subject matter of the technical disclosure. It is submitted with the understanding that it will not be used to interpret or limit the scope of the claims.

### FIELD OF INVENTION

The present invention is directed to a latch mechanism or assembly of the type commonly used on doors and on commercial cabinets and cases, and the like. The present invention provides a door, lid, gate, hatch, cover or other closure device latch mechanism or assembly for retaining a linearly operable bolt element securely by a striker or receiver element that is releasable from either side of the latch by operation of a rotary mechanism actuated by a flush handle on one side or a push button or push cap on the opposite side.

Conventional locks and latch assemblies of the kind commonly used in the above described applications have exhibited a number of problems and drawbacks which the present invention is intended to improve upon. These problems and drawbacks include the use of many parts and often complicated combinations of motions between the parts to provide open and closed latch positions that may be actuated from either side of the door, thereby tending to increase the complexity and cost of the manufacturing process. Additionally, it is often not possible to securely close the door, or other closure device, on which the latching mechanism is installed or mounted when there is a gap of more than a few millimeters between the door and the frame into which the latch bolt seats, so that the latch may relatively easily be forced to a fully open position.

### SUMMARY OF INVENTION

Latch assemblies or mechanisms of the type commonly used on doors or in other commercial applications as referenced above and the like are well known. Examples of such locks or latch assemblies include those described in U.S. Pat. Nos. 6,328,205; 6,247,641; 6,296,181 and 5,794,844.

A general description of the latching mechanism or assembly of the present invention follows. A latch mechanism or assembly for releasably securing a closure element, bolt, from either side of a door by means of independently operable actuators (flush handle and push button or push cap) is provided. It is contemplated that the spring urged linear latch bolt is releasable by operation of a rotary latch mechanism acting upon and in cooperation with an integral bolt cam.

### BRIEF DESCRIPTION OF THE DRAWINGS

FIG. 1 is a front exploded perspective view of the latch mechanism of a preferred embodiment.

FIG. 2 is a side cross-sectional view of the FIG. 1 embodiment installed in a hollow door.

FIG. 3 is a cross-sectional view of the FIG. 4 embodiment along line 3-3.

FIG. 4 is a front view of the FIG. 1 embodiment also depicting rearwardly disposed components hidden from view.

FIG. 5 is a side cross-sectional view of the FIG. 1 embodiment along its longitudinal plane of symmetry in the bolt extended position.

FIG. 6 is a side cross-sectional view of the FIG. 1 embodiment along its longitudinal plane of symmetry in the bolt retracted position.

FIG. 7 is a front view of the handle of the FIG. 1 embodiment.

FIG. 8 is a top view of the handle of the FIG. 1 embodiment.

FIG. 9 is a side view of the handle of the FIG. 1 embodiment.

FIG. 10 is a side partial cross-sectional view of handle of the FIG. 1 embodiment.

FIG. 11 is a front view of the linear bolt of the FIG. 1 embodiment.

FIG. 12 is a side view of the linear bolt of the FIG. 1 embodiment.

FIG. 13 is a bottom view of the linear bolt of the FIG. 1 embodiment.

### DETAILED DESCRIPTION OF PREFERRED EMBODIMENTS

Preferred Embodiment of the Latch Mechanism

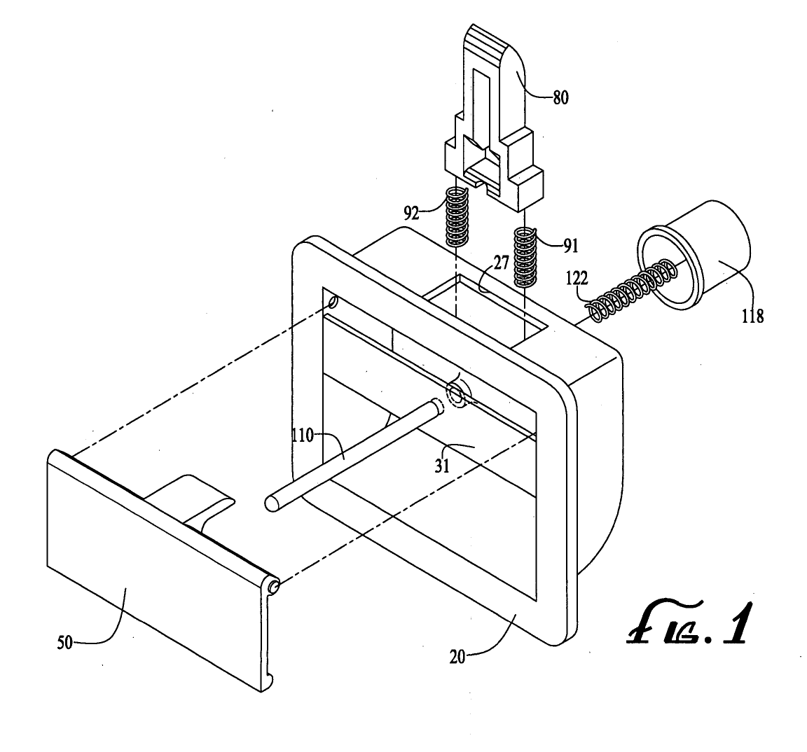

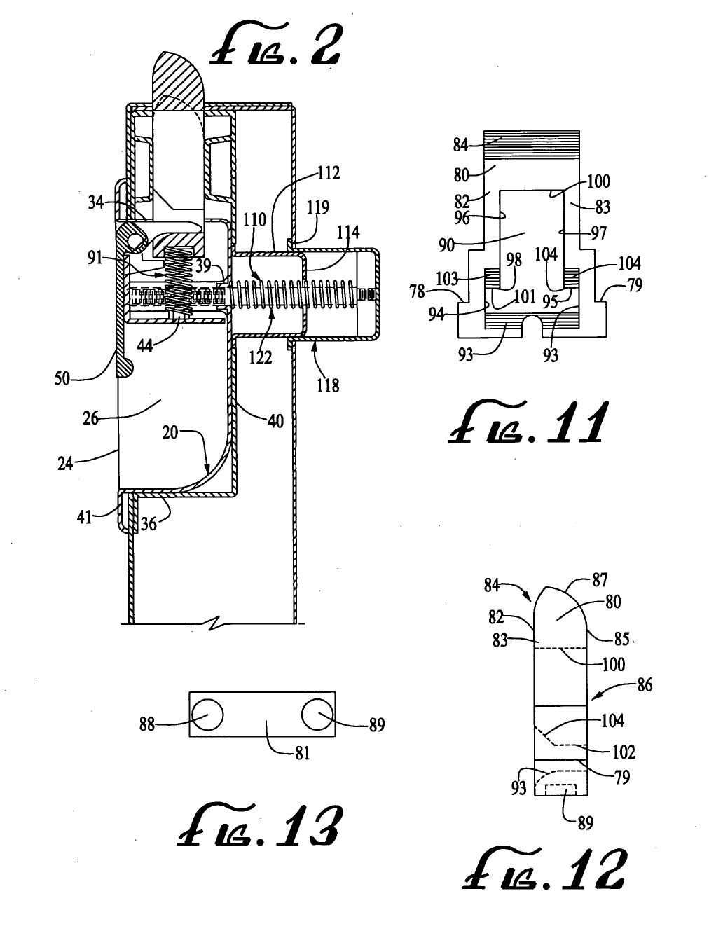

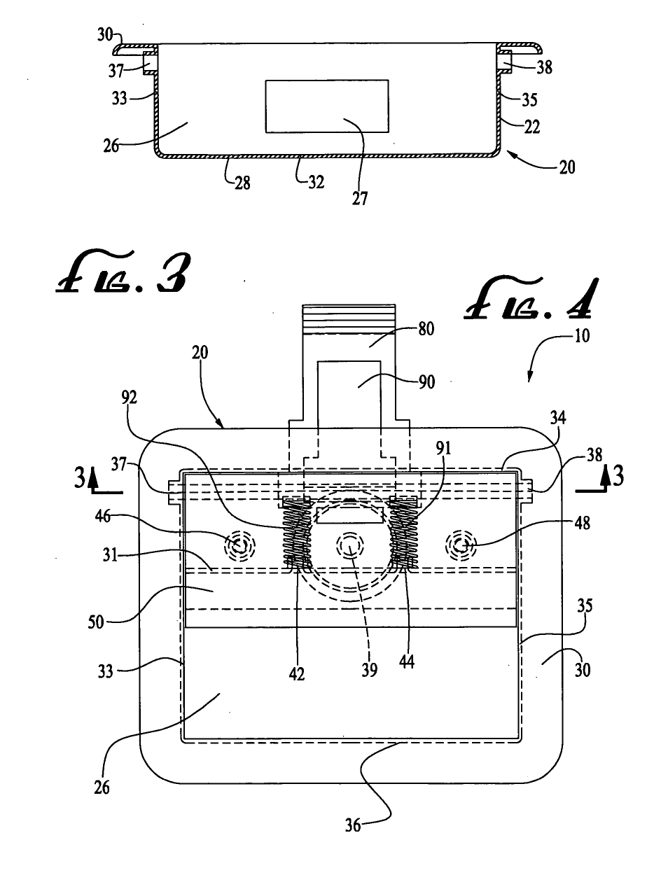

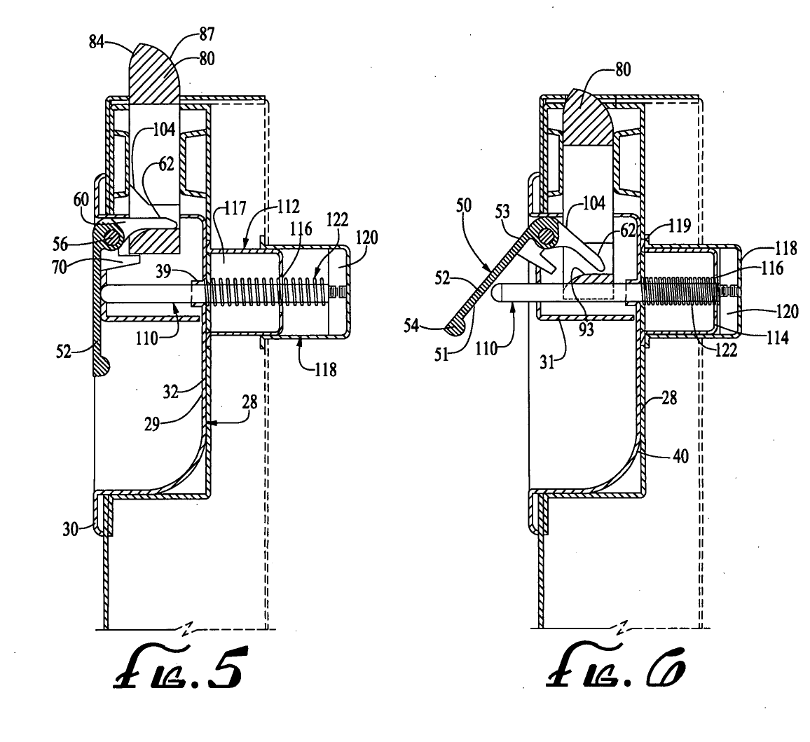

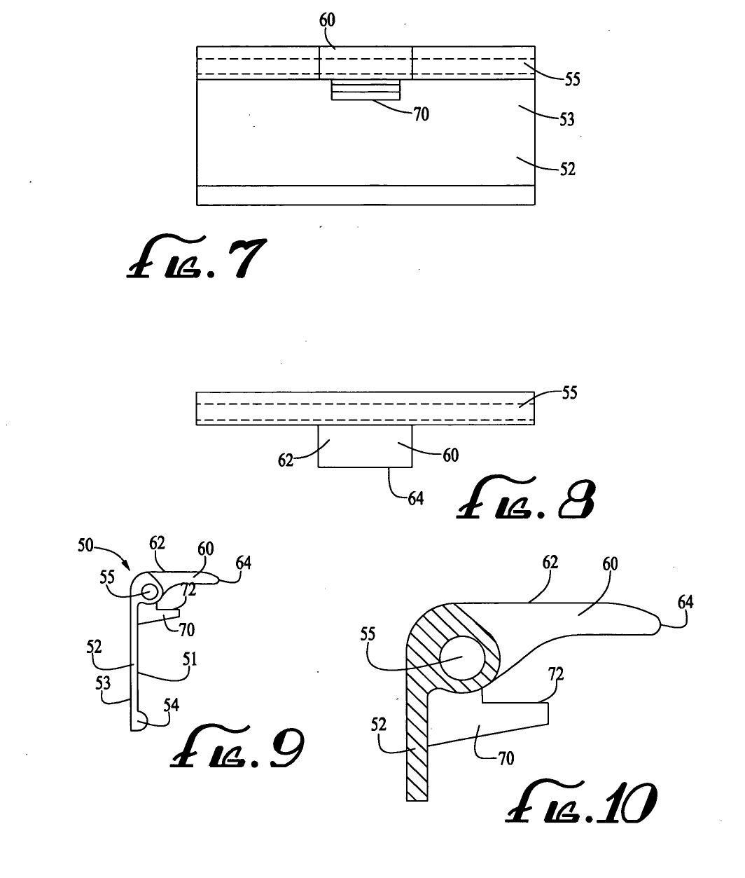

With reference to FIGS. 1-13, a latch assembly mechanism (10) including a housing (20) having a height, a width and a depth formed of an essentially rigid impact resistant and corrosion resistant material such as a polymer or metal, and having a housing wall (22) which may vary in thickness on the order, preferably, of a few millimeters. It is preferred that the housing be made of high impact polymeric material, metal or other material having rigidity and strength sufficient to be used in this field. The housing (20) includes a front side (24) having a front surface (41) in which a housing cavity (26) is formed, and a back side (28). Front side (24) includes rim (30) which forms a lip extending peripherally outward around housing cavity (26). Also, included in front side (24) of housing (20) is cavity floor (32), having cavity floor surface (29), and cavity walls (33), (34), (35) and (36) joining with and surrounding cavity floor (32) and joining cavity floor (32) with rim (30). A first handle axle mounting hole (37) is formed through and penetrates cavity wall (33). A second handle axle mounting hole (38) is formed through and penetrates cavity wall (35). A latch bolt aperture (27) is formed through and penetrates cavity wall (34). A plunger or shaft guide opening (39) is formed through and penetrates cavity floor (32). With further reference to FIGS. 3, 5 and 6, back side (28) of housing (20) includes substantially flat rear surface (40) which is disposed on the opposite surface of housing cavity floor (32) from cavity floor surface (29). Cavity partition wall (31) extends across cavity (26) preferably parallel with cavity wall (34) and is fixed between cavity walls (33), (35) by conventional means. Partition wall (31) includes spring retention pegs (42), (44) formed on partition wall (31) and projecting toward cavity wall (34). Housing mounting holes (46), (48) are formed in cavity floor (32) between partition wall (31) and cavity wall (34).

With reference to FIGS. 1, 2, and 4-10, handle (50) preferably formed of high impact polymeric material or corrosion resistant metal includes grasp plate (52) preferably having a substantially flat outward facing surface (53) and on its opposite inward facing surface (51) having a rounded raised portion (54) to facilitate grasping. Handle (50) is disposed in housing cavity (26) and extends between cavity walls (33) and (35). Handle (50) includes axle bore (55) adapted to receive axle (56). Alex bore (55) defines the length of the longitudinal axis or axis of rotation of handle (50). Axle (56) is preferably formed of a corrosion resistant material such as a corrosion resistant metal or a high impact polymer and is adapted to permit rotation of handle (50) about axle (56). Axle (56) extends through axle mounting hole (37), axle bore (55) and axle mounting hole (38), and is retained in cavities formed by axle mounting holes (37), (38) by press fit, pinning, snap ring or other conventional means to provide a fixed connection. Alex (56) permits handle (50) to rotate with respect to housing (20).

A cam lever plate (60) is preferably integrally formed with and longitudinally centered along handle (50). Cam lever plate (60) extends from handle (50) at a predetermined angle with respect to substantially planar grasp plate (52) and defines substantially planar lever plate upper surface (62), lever plate nose surface (64) and lever plate lower surface (66). In cross-section taken perpendicular to axle bore (55), lever plate nose surface (64) preferably defines a continuously positively curved or convex line of predetermined curvature smoothly joining upper surface (62) and lower surface (66). Each point on nose surface (64) lies at a predetermined distance and angle from the axis of rotation of handle (50). Lever plate lower surface (66) includes a planar portion (65) proximate nose surface (64) and a curvilinear portion (67) distally from nose surface (64). Nose surface (64) and lower surface (66) are adapted to interface with and slidingly contact cam surface (93) of latch bolt (80).

With continued reference to FIGS. 1, 2, 5, 6-10, handle tab (70) is preferably integrally formed with and longitudinally centered along handle (50) but preferably is not as long as cam lever plate (60). Disposed opposite axle bore (55) from cam lever plate (60), the tab (70) extends from handle (50) for a predetermined distance and at a predetermined angle with respect to substantially planar grasp plate (52). Tab (70) defines substantially planar tab upper surface (72) that is substantially parallel with and displaced a predetermined perpendicular distance from the planar portion of lever plate lower surface (66).

With reference to FIGS. 2, 4-6 and 11-13, latch bolt (80) is preferably formed of a block of corrosion resistant metal or high impact polymeric material by machining, casting, molding or other conventional means. Latch bolt (80) preferably includes curvilinear bolt front surface (82) having a substantially planar portion (83) and a convexly curved portion (84), and curvilinear bolt back surface (85) having a substantially planar portion (86) substantially parallel with the substantially planar portion (83) of bolt front surface (82) and a convexly curved portion (87) intersecting with the convexly curved portion (84) of bolt front surface (82). Convexly curved portions (84), (87) of bolt (80) intersect along a line contained in a plane parallel to substantially planar portion (83) of bolt front surface (82). A substantially flat bolt bottom surface (81) is substantially perpendicular to and extends between substantially planar portion (83) of bolt front surface (82) and substantially planar portion (86) of bolt back surface (85), to define the thickness dimension of bolt (80). The thickness dimension defines mutually orthogonal width and length dimensions. The bolt bottom surface (81) in the direction perpendicular to the thickness of bolt (80) defines the width dimension of bolt (80). Naturally, the dimension orthogonal to both the thickness dimension and the width dimension defines the length dimension of bolt (80). It will be evident to one of skill in the art that bolt (80) need not have a substantially rectangular cross-section as described for the present embodiment of the invention, but rather may have any cross-section sufficient to enable useful operation. Spring retention recesses (88), (89) formed in bolt bottom surface (81) align with spring retention pegs (42), (44), respectively, when latch mechanism (10) is fully assembled. Spring retention pegs (42), (44) and spring retention recesses (88), (89) are each adapted to retain bolt coil springs (91), (92), respectively, preferably by friction fit or other conventional means.

Latch bolt (80) includes bolt cavity (90) formed in front surface (82) that preferably completely penetrates bolt (80) from front surface (82) to back surface (85). It will be evident to one of skill in the art that bolt cavity (90) need not completely penetrate bolt (80). Bolt cavity (90) preferably defines eight walls, but may optionally define fewer walls, all of which extend between front surface (82) and back surface (85) in the preferred embodiment where cavity (90) penetrates bolt (80). Bolt cavity (90) defines bolt cavity cam surface (93), two bolt cavity lower side walls (94), (95), two bolt cavity upper side walls (96), (97), two bolt cavity intermediate walls (98), (99), and bolt cavity top wall (100). Bolt cavity cam surface (93) defines a curvilinear surface preferably having a substantially flat portion extending in the width dimension and substantially perpendicular to each of front surface (82) and back surface (85), disposed adjacent bolt back surface (85), and a convexly curved portion adjacent bolt front surface (82). Cam surface (93) of latch bolt (80) is adapted to interface with and slidingly contact lower surface (66) and nose surface (64) of cam lever plate (60). Cam surface (93) extends the width of bolt cavity (90) and has a predetermined width slightly greater than the longitudinal extent of cam lever plate (60) to permit plate (60) to be freely inserted into cavity (90).

With continued reference to FIGS. 2, 4-6 and 11-13, cavity lower sidewalls (94), (95) extend between front surface (82) and back surface (85), and between cam surface (93) and intermediate walls (98), (99), respectively. Cavity lower sidewalls (94), (95) are substantially planar and substantially orthogonal to both bottom surface (81) and each of front surface (82) and back surface (85). Substantially planar cavity top wall (100) extends between front surface (82) and back surface (85), and is substantially parallel to the flat portion of cam surface (93). Substantially planar cavity upper sidewalls (96), (97) extend between front surface (82) and back surface (85), and between cavity top wall (100) and intermediate walls (98), (99), respectively, and are substantially orthogonal to both bottom surface (81) and each of front surface (82) and back surface (85). The pairs of bolt cavity upper sidewalls (96), (97) and cavity lower sidewalls (94), (95) share a common plane of bilateral symmetry. The predetermined distance (in the width dimension) between upper sidewalls (96), (97) is less than the predetermined distance (in the width dimension) between lower sidewalls (94), (95). Intermediate walls (98), (99) are substantially perpendicular to and span between and connect lower sidewalls (94), (95) and upper sidewalls (96), (97), respectively. Intermediate walls (98), (99) each have a preferably flat first portion (101), (102), respectively, parallel with top wall (100) disposed adjacent to back surface (85). Additionally, intermediate walls (98), (99) each have a preferably flat second portion (103), (104) adjacent to front surface (82) joining with and disposed at a predetermined angle with respect to the flat first portions (101), (102), respectively. It will be evident to one of skill in the art that intermediate walls (98), (99) may be curved or curvilinear as well as flat, and that cavity (90) may have a uniform width along its entire length.

With reference to FIGS. 4, 5 and 6, a push button or push cap assembly for actuation of the latch mechanism from the side of the door or closure device opposite handle (50) will be described. The plunger or shaft guide aperture or guide opening (39) formed in cavity floor (32) is adapted to permit a plunger or shaft (110) to pass freely and slidingly therethrough but to not admit shaft coil spring (122) disposed around shaft (110). Guide opening (39) is aligned with handle (50) to permit shaft (110) passing through opening (39) to contact the inward facing surface (51) of handle (50). Guide cap (112) preferably defines a right circular cylinder of predetermined inside and outside diameters having a substantially smooth outer surface and having an open end (117) affixed to the rear surface (40) of the back side (28) of housing (20) by conventional means such as adhesive, welding, sonic welding, fasteners or the like. Guide cap (112) is partially closed by a diaphragm (114) extending across its inside diameter. Diaphragm (114) is penetrated by diaphragm opening (116) that is disposed in overlying alignment with opening (39) and sized to admit shaft (110) and shaft coil spring (122) surrounding shaft (110). Push button or push cap (118) preferably defines a right circular cylinder of predetermined inside and outside diameters having a substantially smooth inner surface sized and adapted to slide smoothly over the outer surface of guide cap (112). Push button or push cap (118) has an open end adapted to admit guide cap (112) and a closed opposite end adapted to be pushed by a human digit. Push button or push cap (118) is retained on guide cap (112) by means of a flange (119) extending circumferentially outwardly from its outside diameter adapted to limit the range of travel of push button or push cap (118) by contact with a portion of the door or closure device in which latch mechanism (10) is mounted through which push button or push cap (118) extends. It will be evident to one of skill in the art that push button or push cap (118) may be retained on guide cap (112) by means such as a pin, snap ring or the like fixed to shaft (110) on the distal side of opening (39) from support element (120). Support element (120) affixed to push button or push cap (118) secures shaft or plunger (110) to push button or push cap (118) by conventional means such as threads, press fit, adhesive, fasteners and the like. Shaft (110) is preferably circular in cross-section and defines a central axis extending from an end secured to push button or push cap (118) to an opposite free end that preferably is rounded. Shaft (110) is disposed such that when latch mechanism (10) is assembled, shaft (110) passes through openings (39) and (116). Shaft coil spring (122) is disposed around shaft (110) between support element (120) and the rear surface (40) of housing (20) and is adapted to slide along shaft (110) whether in compressed or extended conformation.

In use, the latch assembly mechanism (10) is typically installed in a hinged door panel with the latch rim (30) resting against a substantially flat exterior surface of the door panel and the housing (20) substantially contained within the door panel with the latch bolt (80) extending beyond the edge of the door panel and push button or push cap (118) extending through an opening in the opposite exterior surface of door panel from rim (30). Mounting of the latch assembly mechanism (10) to a door panel is preferably by means of convention fasteners inserted through mounting holes (46), (48) formed in cavity floor (32) and preferably positioned between cavity wall (34) and partition wall (31). Correspondingly, a striker or striker plate having a cavity or hole adapted to receive latch bolt (80) is typically installed on a frame adjacent to or surrounding the door panel. The latch is oriented so that as the panel is closed into the frame, or when the frame and panel are brought substantially into the same plane, the striker or striker plate first contacts the convex back surface (87) of bolt (80) at an angle to the longest dimension, or length, of the latch bolt. As the door panel continues to be closed, the striker presses against the convex back surface (87) causing the bolt (80) to retract or move into the latch housing (20). Once the striker moves past or beyond the intersection of convex back surface (87) with convex front surface (84) of bolt (80), the restoring force of the coil springs (91), (92) quickly returns the bolt (80) to its previous extended at rest position. At this point, the bolt (80) is positioned between the striker and the rim, lip, plate or other conventional latch covering element of the frame and the door panel is held in a fully closed position until the latch is released. In the case of a striker plate, once the intersection of convex back surface (87) with convex front surface (84) of bolt (80) moves beyond the edge of the striker cavity, the restoring force of the coil springs (91), (92) quickly returns latch bolt (80) to its previous extended at rest position. At this point, the bolt is positioned in the striker plate cavity and the door panel is held in a fully closed position until the latch is released.

The Closed Position of the Latch Assembly Mechanism

With reference to FIGS. 2, 5 and 6, the latch is in its closed position when handle (50) is substantially flush with rim (30) and the push button or push cap (118) is fully extended. In the closed position, shaft coil spring (122) is extended, urging push button or push cap (118) to contact an outward travel limiting stop, shown in FIG. 2 as flange (119) contacting an inner portion of the door or closure device, in which the assembly is installed. Shaft (110) is in a fully retracted position when push button or push cap (118) is urged against its outward travel limiting stop. When fully retracted shaft (110) is not in contact with inward facing surface (51) of handle (50).

In the closed position, bolt (80) is urged to its fully extended position by bolt coil springs (91), (92), and the travel of bolt (80) in the extended direction is limited by contact between cavity wall (34) adjacent bolt aperture (27) and bolt flanges (78), (79) formed on bolt (80). Also, in the closed position, cam surface (93) of bolt (80) rests against the lower surface (66) of cam level plate (60) of handle (50). When in the closed position, a portion of the upper surface (72) of handle tab (70) is positioned overlying and immediately adjacent bolt bottom surface (81). Thus, over rotation of handle (50) into cavity (26) is prevented by interfering contact between upper surface (72) of handle tab (70) and bolt bottom surface (81). Thus, in the closed position with the bolt in its fully extended position, handle (50) is held in an at rest position with handle planar grasp plate (52) substantially flush with rim (30).

The Operation of the Latch Assembly Mechanism by Means of the Flush Handle

With additional reference to FIGS. 2, 5 and 6, the latch is opened from the closed position by pulling handle grasp plate (52) outward or away from cavity floor (32) thus causing handle (50) to rotate about axle (56) against the restoring force of bolt coil springs (91), (92). The rotation of handle (50) causes the cam lever plate (60) to pivot thereby moving nose surface (64) to contact cam surface (93) of bolt (80). Continuing rotation of handle (50) causes nose surface (64) of cam lever plate (60) to slide upon and to push against cam surface (93) thus moving bolt (80). Because the motion of nose surface (64) is confined to a plane substantially perpendicular to the axis of axle (56), the rotation of cam lever plate (60) in turn causes the point of contact between cam surface (93) and nose surface (64) to transcribe an arc, the component of which along the direction of movement of bolt (80) represents the translation of bolt (80) between the closed or fully extended position and the open or retracted position. Further rotation of handle (50) causes the upper surface (62) of cam lever plate (60) to interferingly contact intermediate walls (98), (99) of bolt (80) thus stopping and preventing further rotation of handle (50). When surfaces (103), (104) of bolt cavity intermediate walls (98), (99) contact upper surface (62), latch bolt (80) is fully retracted. In the fully retracted position, bolt (80) is disengaged from any striker element or other such device on the door frame and the door panel is free to be opened. When handle (50) is released, the restoring force of bolt coil springs (91), (92) returns bolt (80) to its extended at rest position and action of cam surface (93) upon lever plate (60) returns handle (50) to its flush at rest position. In the present embodiment the translation of latch bolt (80) between the closed and open positions of the latch assembly mechanism (10) has a range of at least about 11 millimeters to about 12 millimeters.

The Operation of the Latch Assembly Mechanism by Means of the Push Button

With reference to FIGS. 2, 5 and 6, the latch assembly mechanism (10) is operated by application of an inward or pushing force on push button or push cap (118) which causes shaft (110) to slide within shaft guide opening (39) against the restoring force of shaft coil spring (122). Continued application of pushing force on push button or push cap (118) causes shaft (110) to contract the inward facing surface (51) of handle (50). Upon further application of pushing force on push button or push cap (118) to its fully depressed position or station, shaft (110) presses against handle (50) causing it to rotate about axle (56) as described above for operation of the flush handle feature and the latch assembly mechanism (10) operates as described above. Upon release of the inward or pushing force on push button or push cap (118), the action of shaft coil spring (122) returns shaft (110) to its initial rest position with push button or push cap (118) in its fully extended position or station. When push button or push cap (118) is released, the restoring force of bolt coil springs (91), (92) returns bolt (80) to its extended at rest position and action of cam surface (93) upon lever plate (60) returns handle (50) to its flush at rest position.

While the present invention has been described in connection with what are presently considered to be the most practical and preferred embodiments, it is to be understood that the invention is not to be limited to the disclosed embodiments, but to the contrary, is intended to cover various modifications and equivalent arrangements included within the spirit of the invention, which are set forth in the appended claims, and which scope is to be accorded the broadest interpretation so as to encompass all such modifications and equivalent structures.

What is claimed is:

1. A latch assembly comprising:
a housing having a height, a width and a depth;
a handle rotatably disposed within and along the width of the housing;
a first spring and a second spring mounted within in the housing and adapted to bias the handle to a first handle position;
a latch bolt mounted in the housing and adapted to reciprocate from a first latch bolt position to a second latch bolt position in response to rotation of the handle from the first handle position to a second handle position;
a shaft mounted in the housing and adapted to reciprocate from a first shaft position to a second shaft position;
a third spring mounted within the housing and adapted to bias the shaft to the first shaft position; and,
the handle and the shaft operatively positioned with respect to each other and adapted to cause rotation of the handle from the first handle position to the second handle position in response to reciprocation of the shaft from the first shaft position to the second shaft position.

2. A latch assembly comprising:
a housing having a height, a width and a depth;
a handle rotatably disposed within and along the width of the housing;
a first spring and a second spring mounted within in the housing and adapted to bias the handle to a first handle position;
a cam lever affixed to said handle responsive to rotation of the handle;
a latch bolt mounted in the housing and adapted to reciprocate from a first latch bolt position to a second latch bolt position;
the first spring and the second spring further adapted to bias the latch bolt to a first latch bolt position;
the cam lever disposed in sliding contact with the latch bolt to cause the latch bolt to reciprocate from the first latch bolt position to the second latch bolt position in response to rotation of the handle from the first handle position to a second handle position;
a shaft mounted in the housing and adapted to reciprocate from a first shaft position to a second shaft position;
a third spring mounted within the housing and adapted to bias the shaft to the first shaft position; and,
the handle and the shaft operatively positioned with respect to each other and adapted to cause rotation of the handle from the first handle position to the second handle position in response to reciprocation of the shaft from the first shaft position to the second shaft position.

3. A latch assembly comprising:
a housing having a height, a width and a depth and including a front side and a back side;
a handle defining an axis of rotation rotatably disposed within and along the width of the housing;
a first spring and a second spring mounted within in the housing and adapted to bias the handle to a first handle position;
a cam lever formed on the handle responsive to rotation of the handle and extending a predetermined distance from the handle axis of rotation;
a latch bolt mounted in the housing and adapted to reciprocate from a first latch bolt position to a second latch bolt position;
the first spring and the second spring further adapted to bias the latch bolt to a first latch bolt position;
a latch bolt cavity including a latch bolt cam surface formed in the latch bolt;
the cam lever and the latch bolt cam surface adapted to contact and to slide one upon the other to cause the latch bolt to reciprocate from the first latch bolt position to the second latch bolt position in response to rotation of the handle from the first handle position to a second handle position;
the cam lever and the latch bolt adapted to make interfering contact to prevent further rotation of the handle when the handle is in the second handle position and the latch bolt is in the second latch bolt position;
a guide cap having a first end with an opening and a second end with an opening in alignment with a shaft guide opening formed in the housing affixed to the back side of the housing;
a push cap adapted to reciprocate upon and along the guide cap between a first push cap position and a second push cap position slidingly retained on the guide cap;
a shaft affixed to said push cap extending through the first end opening and the second end opening of the guide cap and the shaft guide opening;
the shaft adapted to reciprocate from a first shaft position to a second shaft position;
a third spring mounted within the push cap and adapted to bias the push cap to the first push cap position and to bias the shaft to the first shaft position; and,
the handle and the shaft operatively positioned with respect to each other and adapted to cause rotation of the handle from the first handle position to the second handle position in response to reciprocation of the shaft from the first shaft position to the second shaft position in response to reciprocation of the push cap from the first push cap position to the second push cap position.
